(19) United States
(12) Patent Application Publication
(10) Pub. No.: US 2014/0114964 A1
(43) Pub. Date: Apr. 24, 2014

(54) SYSTEM AND METHOD FOR SUPPORTING A SEARCHING PROCESS IN A SUPPLY CHAIN MANAGEMENT ENVIRONMENT

(71) Applicant: M3 Technology, Inc., Houston, TX (US)

(72) Inventors: Dong Dong, Sugar Land, TX (US); Steven Green, Houston, TX (US)

(73) Assignee: M3 Technology, Inc., Houston, TX (US)

(21) Appl. No.: 14/028,209

(22) Filed: Sep. 16, 2013

Related U.S. Application Data
(60) Provisional application No. 61/701,367, filed on Sep. 14, 2012.

(51) Int. Cl. G06F 17/30

(52) U.S. Cl. CPC G06F 17/3053
USPC 707/723; 707/767; 707/722

(57) ABSTRACT

A system and method support a search process in a supply chain management environment, in order to make finding supply chain information simple. The search process can make instantaneous search suggestion based on different supply chain information categories in the environment. Furthermore, special search keywords can be used as shortcut for finding supply chain information. Also, the system can organize and display the search results in a clear and intuitive fashion, such as displaying the search results in multiple sections with mixing of graphs and texts. Additionally, the search process can be used together with other supply chain management processes.

### CLAIM OF PRIORITY

This application claims priority on the following application, which is hereby incorporated by reference in its entirety:

U.S. Provisional Application No. 61/701,367, entitled “SYSTEM AND METHOD FOR SUPPORTING A SEARCHING PROCESS IN A SUPPLY CHAIN MANAGEMENT WORKSPACE,” filed on Sep. 14, 2012.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates generally to supply chain management, and relates more particularly to supporting a searching process in a supply chain management workspace.

### BACKGROUND

A supply chain describes the movement and storage of raw materials, work-in-process inventory, and finished goods from point of origin to point of consumption. A supply chain management environment can manage interconnected businesses and/or facilities involved in the provision of product and service packages in the supply chain. This is the general area that embodiments of the invention are intended to address.

### SUMMARY

Described herein are systems and methods that can support a supply chain management platform for a supply chain management environment. The supply chain management platform can provide a graphical representation of one or more material inventory trends in the supply chain management environment. Additionally, the supply chain management platform can using one or more tokens on the graphical representation of the one or more material inventory trends to display one or more activities, wherein the one or more activities contribute to inventory change in the supply chain management environment. Furthermore, the supply chain management platform allows a user to perform one or more supply chain scheduling operations in the supply chain management environment based on the graphical representation.

### BRIEF DESCRIPTION OF THE DRAWINGS

FIG. 1 is an exemplary illustration of providing a graph view in a supply chain management workspace, in accordance with an embodiment of the invention.

FIG. 2 is an exemplary illustration of providing a trend view in a supply chain management workspace, in accordance with an embodiment of the invention.

FIG. 3 is an exemplary illustration of supporting a search process in a supply chain management workspace, in accordance with an embodiment of the invention.

FIG. 4 is an exemplary illustration of supporting a search process in a supply chain management workspace in accordance with an embodiment of the invention.

FIG. 5 is an exemplary illustration of a flow diagram for supporting charting in a supply chain management environment, in accordance with various embodiments of the invention.

FIG. 6 is an exemplary illustration of supporting a supply chain management process in accordance with an embodiment of the invention.

FIG. 7 is an exemplary illustration of a flow diagram for supporting charting in a supply chain management environment, in accordance with various embodiments of the invention.

FIG. 8 is an exemplary illustration of starting a search process in an exemplary supply chain management workspace, in accordance with an embodiment of the invention.

FIG. 9 is an exemplary illustration of providing automatic suggestion for a search process in an exemplary supply chain management workspace in accordance with an embodiment of the invention.

FIG. 10 is an exemplary illustration of displaying search results based on a location in an exemplary supply chain management workspace in accordance with an embodiment of the invention.

FIG. 11 is an exemplary illustration of displaying search results based on a location group in an exemplary supply chain management workspace in accordance with an embodiment of the invention.

FIG. 12 is an exemplary illustration of displaying search results based on a material in an exemplary supply chain management workspace in accordance with an embodiment of the invention.

FIG. 13 is an exemplary illustration of displaying search results based on a transit mode in an exemplary supply chain management workspace in accordance with an embodiment of the invention.

FIG. 14 is an exemplary illustration of displaying search results based on a time period in an exemplary supply chain management workspace in accordance with an embodiment of the invention.

FIG. 15 is an exemplary illustration of displaying a Graph View in an exemplary planning board in accordance with an embodiment of the invention.

FIG. 16 is an exemplary illustration of displaying a Trend/Gantt View in an exemplary planning board in accordance with an embodiment of the invention.

FIG. 17 is an exemplary illustration of displaying a Grid View in an exemplary planning board in accordance with an embodiment of the invention.

FIG. 18 is an exemplary illustration of displaying a Graph/Grid View in an exemplary planning board in accordance with an embodiment of the invention.

FIG. 19 is an exemplary illustration of displaying a Trend/Grid View in an exemplary planning board in accordance with an embodiment of the invention.

FIG. 20 is an exemplary illustration of displaying a Trend Chart in an exemplary planning board in accordance with an embodiment of the invention.

### DETAILED DESCRIPTION

The invention is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

### Supply Chain Management Workspace

A supply chain management workspace can simplify supply chain planning process in a supply chain management environment by combining data from disparate sources. The supply chain management workspace can automate the synthesis of forecast, scheduling, planning and actual operating data for seamless viewing and analysis. The supply chain management workspace enables various users in different industries, such as hydrocarbon supply chain and raw material supply chain, to move quickly and methodically to meet different challenges with ease.

In accordance with an embodiment of the invention, the supply chain management workspace can be either a supply chain management software application, e.g. SIMTO Planning Workspace Pro (PW Pro), or a web service that is based on the supply chain management software.

In accordance with an embodiment of the invention, the supply chain management workspace can capture various supply chain events. For example, the supply chain management workspace can track stock transfers, trades, exchanges, demands, plant production, and other supply chain events. Also, the supply chain management workspace can provide customizable data fields to store the information that a use may need.

The supply chain management workspace can track stock transfers, which indicates the movements of materials between locations in a user's supply chain across different methods of transport. Also, the supply chain management workspace can automatically note the effect of transfers on inventories and computes in-transit inventories.

The supply chain management workspace can track trades, which indicates the purchase and sales activities that can be manually entered or loaded via integration. The supply chain management workspace can check inventory constraints and identify problems caused by infeasible trades.

The supply chain management workspace can track exchanges, such as the exchanges of materials with third parties, and can store relevant associated information, such as agreement number, while also providing flexibility via user-defined fields.

The supply chain management workspace can track demand forecast. For example, the supply chain management workspace can track and report the anticipated demand for products, including blended products. Alternative demand scenarios and their financial impacts can be analyzed using the plan comparison tools built into the supply chain management workspace.

The supply chain management workspace can track plant production. For example, the supply chain management workspace allows a user to edit plant production and consumption data in a simple grid-based format. Additionally, the supply chain management workspace can identify inventory shortages automatically.

The supply chain management workspace can track price forecast, which indicates the price information across a user's entire supply chain and uses it automatically in the tabulation of built-in financial reports, such as the gross margin report. Furthermore, the price forecast data can also be used in custom reporting.

The supply chain management workspace can track inventory constraints, such as specifying constraints for individual locations or a whole region and for individual materials or an entire material category. When planned inventories fall outside of these limits, the supply chain management workspace can bring such occurring to a user's attention in tabular and graphical form.

The supply chain management workspace can track product recipes, which includes user recipes that specify how a product is made up of other components. The supply chain management workspace can apply that information when calculating inventories. The supply chain management workspace also supports recipes that vary over time, so that seasonal variations are allowed.

The supply chain management workspace can provide user-defined fields. For example, the supply chain management workspace provides the flexibility to easily store the data an organization requires by creating a user-defined field. Also, extensive validation options provide the user with the ability to specify precisely what type of data (e.g. floating-point numbers, integers, strings, etc.) and which values are allowed in each field.

Thus, the supply chain management workspace, e.g. PW Pro, knows what is happening in a user's supply chain, since the supply chain management workspace can use built-in fields to keep track of user's data and can use user-defined fields to extend the functionality to support the different requirements in user's supply chain.

Additionally, the supply chain management workspace allows users to visualize the supply chain. For example, PW Pro can provide graphs and charts to display material flows and inventory in a user's supply chain over time.

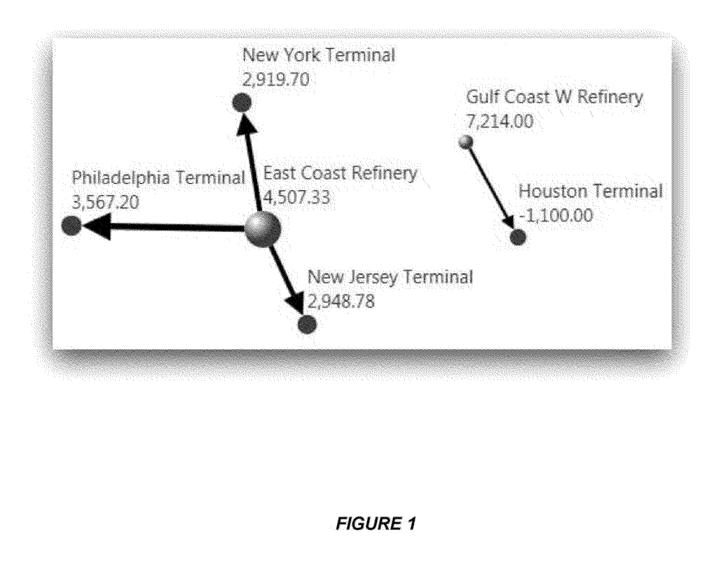

FIG. 1 is an exemplary illustration of providing a graph view in a supply chain management workspace, in accordance with an embodiment of the invention. As shown in FIG. 1, the graph view 100 can display a diagram indicating the movements of materials across a supply chain over a selected time. Here, the relative size of the nodes and arrows in the diagram indicate the relative size of the material movements.

Additionally, the system allows a user to use various filters to view the selected locations, materials and activities that a user is interested. Furthermore, when a user click on the graph, the system can bring up the activities associated with that location in the data grid, where the user can modify them.

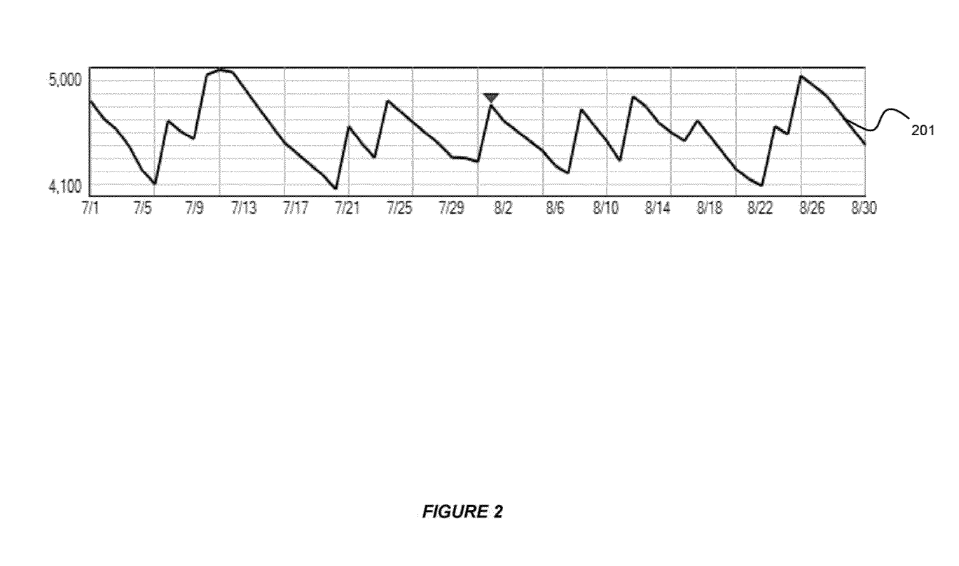

FIG. 2 is an exemplary illustration of providing a trend view in a supply chain management workspace, in accordance with an embodiment of the invention. As shown in FIG. 2, the trend view 200 can display inventories at each of the locations in a supply chain. A material filter allows a user to specify which materials or material groups are displayed in the inventory trend curve 201. Furthermore, when a user expands any location in the graph view, the supply chain management workspace can display curves for each individual material at the particular location along with visual representations of the activities that occur at the particular location.

In accordance with an embodiment of the invention, the supply chain management workspace can be used by a user to find data in a supply chain, e.g. a large supply chain. For example, a search engine can be built into the supply chain management workspace, to support tracking the supply chain data. Additionally, relevant suggestions can appear automatically as the user types.

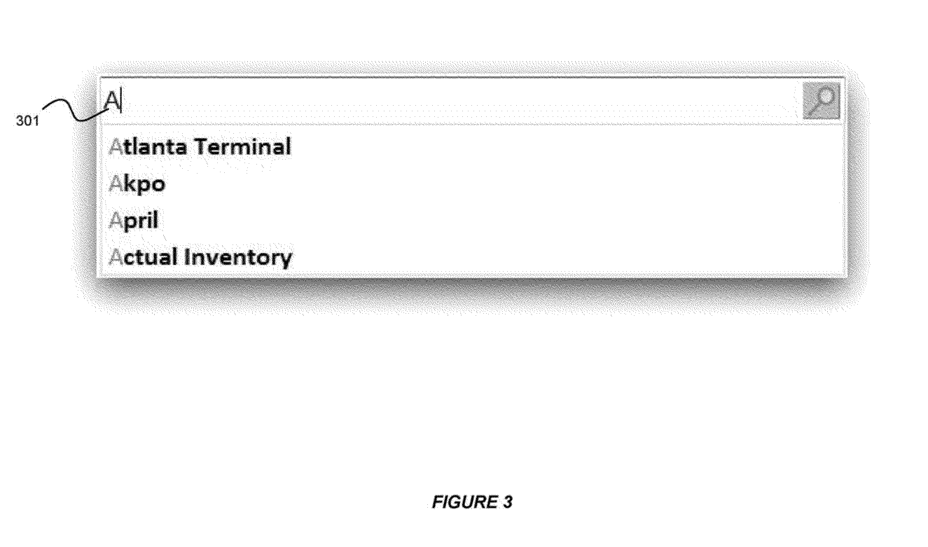

FIG. 3 is an exemplary illustration of supporting a search process in a supply chain management workspace, in accordance with an embodiment of the invention. As shown in FIG. 3, as soon as a user begins typing, e.g. a character “A” 301 in the search box, the supply chain management workspace 300 can suggest relevant information to the user, e.g. “Atlanta Terminal”, “Akpo”, “April”, “Actual Inventory”.

Once a user submits a query, the supply chain management workspace can bring up reports and activity data directly on the search page. Furthermore, in order to find out more details into the data, a user can simply click on the report and the system can open the report in a separate tab.

In accordance with an embodiment of the invention, the supply chain management workspace can be used to review comprehensive reports. For example, PW Pro allows a user to manipulate and organize supply chain data by location, material or any other data field, and/or daily, weekly, monthly or any other time range. Additionally, PW Pro allows a user to build customized reports.

Furthermore, the supply chain management workspace can include built-in reports and editors that can display information on various aspects of a supply chain, such as Supply & Demand Balance, Inventory Projection, Stock Transfers, Trades, Inventory Projection, Inventory Constraint Violations, Actual Inventory, Demand Forecast, Exchanges, Inventory Limits, Prices, Plant Production, and Recipes.

Additionally, the supply chain management workspace can provide reports that feature integrated trend charts. A user is allowed to simply click on the chart active button and then click on a report row to display the data curve for that row. The reports also feature integrated filters for relevant fields, such as Location and Material and time frame. A user is also allowed to toggle the summation feature to display totalized values for the selected fields.

Furthermore, the supply chain management workspace lets a user to combine data from different supply chain aspects into a single report. Also, the supply chain management workspace lets a user to define customized reports. For example, customized reports can have multiple sections, user-specified styles, and arbitrary mathematical transformations of supply chain data.

In accordance with an embodiment of the invention, the supply chain management workspace can work in a connected mode or a stand-alone mode. For example, PW Pro is an enterprise software application that can support hundreds of users by running from a centralized database. On the other hand, PW Pro can also support file-based models so that a user can work independently on a personal computer without ever connecting to a database.

Within the supply chain management workspace, multiple users can access and modify the same model simultaneously by connecting to a centralized database. Furthermore, the supply chain management workspace can include specialized features for enterprise users. For example, the PW Pro Audit Trail mechanism tracks changes to plan data, noting who made the changes and at what time, for later review if needed. The User Activity Report can show which users have accessed the system and can provide a summary of the types of modifications they have made. Additionally, the supply chain management workspace can provide a concurrency mode selector, which can control whether to allow users to edit the same plan simultaneously. Also, users are allowed to access and modify the same plan at the same time, but administrators may change this setting to prevent users from making simultaneous edits to the same plan.

In a stand-alone mode, the supply chain management workspace can support file-based models. When running from a file, the supply chain management workspace functions as a single-user application, with all plan and model data stored in the file, without sacrificing functionality. This option is preferable for single-user scenarios where installing and maintaining a centralized database is unnecessary.

### Search Process in a Supply Chain Management Workspace

In accordance with an embodiment of the invention, the supply chain management workspace can support a searching process, which can make finding supply chain information simple. The search process can make instantaneous search suggestion to the user based on different supply chain information categories in the workspace. The searching process can suggest multiple search items that match multiple categories of supply chain information. Furthermore, special search keywords can be used as shortcut for finding supply chain information. Also, the workspace can organize and display the search results in a clear and intuitive fashion, e.g. displaying the search results in multiple sections with mixed graphs and texts.

Additionally, the search process can be used together with other supply chain management processes, and can facilitate a complete and rich user experience for the supply chain management workspace.

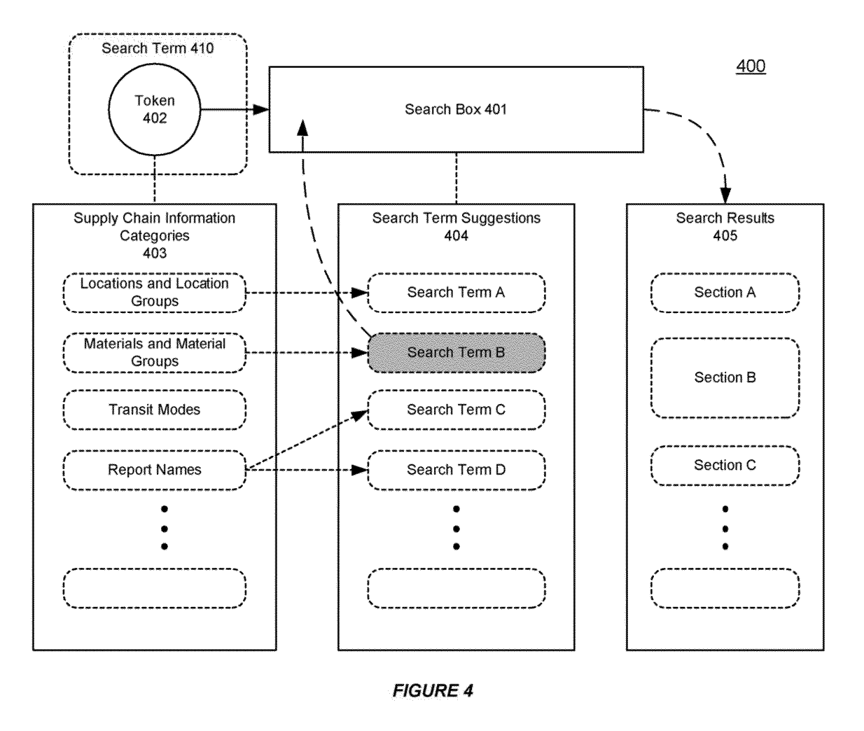

FIG. 4 is an exemplary illustration of supporting a search process in a supply chain management workspace in accordance with an embodiment of the invention.

As shown in FIG. 4, a supply chain workspace 400 can provide a user interface, e.g. a search box 401, to assist a user in finding supply chain information. The supply chain workspace 400 can start searching for relevant supply chain information after receiving a search term 410 in the search box 401.

The search term 410 can be based on different types of media, and/or in different forms. For example, the search term can be a word or a sentence typed in a graphic search box. Additionally, the search term can be a word or a sentence extracted from a vocal instruction by the user, e.g. using various voice recognition and natural language parsing technologies.

Furthermore, the supply chain workspace 400 can provide the user with suggested search terms 404 based on an inputted token 402, so that the user does not have to enter the whole search term 410. The inputted token 402 can be a part of the search term 410. For example, the token 402 can be one or more characters typed in a search box 401, or a word extracted from a vocal instruction by the user.

Then, the workspace can match the received token with a set of supply chain information categories 403 provided in the supply chain workspace 400, and provide search term suggestions 404 to the user on how to complete the search term 410 that can be used to find supply chain information in the supply chain management workspace.

The search term suggestions 404 can include a list of suggested search terms based on the supply chain information categories 403 in the supply chain workspace 100. In the example as shown in FIG. 4, a “Search Term A” can be suggested based on the “Locations and Location groups” category, and a “Search Term B” can be suggested based on the “Materials and Material groups” category. Additionally, two suggested search terms, “Search Term C” and “Search Term D” are provided to the user for the “Report names” category, while no suggested search term is available for the “Transit Modes” category.

Additionally, the supply chain workspace can use various special keywords as the search term in order to make the searching more powerful and convenient.

The user can complete the intended search term 410, either by selecting one of the suggested search terms from the search term suggestions 404 or by entering the complete search term manually. As shown in FIG. 4, the user can select “Search Term B” from the list of suggested search terms 404.

After the user completes entering the search term, the supply chain workspace 400 can display one or more searching results 405 to the user. The searching results 405 can be displayed in different sections. For example, the searching results can be displayed on different tabs in a graphical user interface, e.g. Sections A-C. Furthermore, the user can click on a section to open a separate tab that contains the filtered information for a particular section of search results. Additionally, the separate tab can offer additional features such as interactive charting, calculating and information editing.

In accordance with an embodiment of the invention, the supply chain workspace 400 can order searching results 405 and searching suggestions 404 by relevance within a supply chain management environment. The supply chain workspace 400 can first categorize various supply chain information in the supply chain management environment. Then, the supply chain workspace 400 can determine a relevance ranking for each category of supply chain information. Furthermore, the supply chain workspace 100 can display searching results in sections sorted in an order based on the relevance ranking.

For example, the supply chain workspace 400 can establish a fixed relevance ranking of different supply chain information categories. Additionally, the supply chain workspace 400 can store user interaction information in search requests, and calculate a relevance ranking of supply chain information categories based, in whole or in part, on stored user interaction information. Also, the supply chain workspace 400 can store feasibility information about a supply chain plan, and calculate a relevance ranking of supply chain information categories based, in whole or in part, on stored feasibility information about a supply chain plan.

Furthermore, the supply chain workspace 400 can organize supply chain information in searching results 405 in response to a user entering a special duration organizational keyword within a supply chain management environment. The supply chain workspace 400 can determine a set of special duration organizational search keywords (e.g. ‘weekly’, ‘daily’, ‘monthly’) and establish a mapping of special duration organizational search keywords to a duration of time (e.g. mapping ‘daily’ to one day, ‘weekly’ to one week). Then, the supply chain workspace 400 can organize information in searching results in response to a user entering a search token that is one of the special duration organizational search keywords based on the mapped duration of time.

Additionally, the supply chain workspace 400 can organize supply chain information in searching results within a supply chain management environment in response to a user entering a time interval. The supply chain workspace 400 can first determine a default time zone for the display of information to the user, and convert search tokens into time intervals within the default time zone. Then, the supply chain workspace 100 can convert supply chain information stored with Coordinated Universal Time (UTC) dates and times into dates and times in the default time zone, and can filter supply chain information based on the converted time interval. In addition, the user can select which time zone to use as the default time zone.

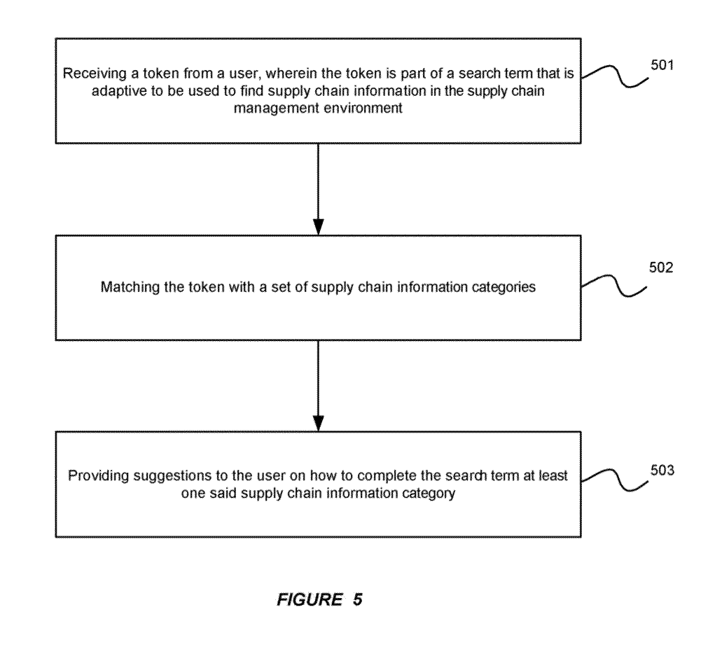

FIG. 5 is an exemplary illustration of a flow diagram for supporting charting in a supply chain management environment, in accordance with various embodiments of the invention. As shown in FIG. 5, at step 501, a supply chain workspace can receive a token from a user, wherein the token is a part of a search term that is adaptive to be used to find supply chain information in the supply chain management environment. Then, at step 502, the supply chain workspace can match the token with a set of supply chain information categories. Furthermore, at step 503, the supply chain workspace can provide suggestions to the user on how to complete the search term at least one said supply chain information category.

### Search Results in a Supply Chain Management Workspace

In accordance with an embodiment of the invention, the supply chain management workspace can find the data that a user is looking for and can display the search results in multiple sections.

The supply chain management workspace can include a supply chain graph in the search results. If a search query encompasses more than a single location, the search results can include a diagram showing the movements of the selected materials between locations during the selected time interval.

The supply chain management workspace can also include a trend chart in the search results. The trend chart displays the combined inventory for all the locations and materials.

The supply chain management workspace can also include inventory limit violations in the search results. If a user searches for a location, location group, material or material group, the supply chain management workspace can check for inventory limit violations and display them in tabular form (if exist, with negative numbers indicating underflows and positive numbers indicating overflows).

The supply chain management workspace can also include a transfer plan in the search results. If a user searches for a location, location group, material, material group, transit mode, shipment or receipt activity type, or any user defined value that appears in a transfer or transfer group, the supply chain management workspace can display aggregated transfer data in tabular form, based on the columns that a user has selected in the transfer plan editor.

The supply chain management workspace can also include various transfer activities in the search results. If a user searches for a specific transfer or transfer group ID or any user defined value that appears in a transfer or transfer group, the supply chain management workspace can display all matching transfers in tabular form.

The supply chain management workspace can also include a trade plan in the search results. If a user searches for a location, location group, material, material group, agreement, purchase or sale activity type, or any user defined value that appears in a trade, the supply chain management workspace can display aggregated trade data in tabular form, based on the columns a user has selected in the trade plan editor.

The supply chain management workspace can also include various trade activities in the search results. If a user searches for a specific trade ID or any user defined value that appears in a trade, the supply chain management workspace can display all matching trades in the tabular form.

The supply chain management workspace can also include an exchange plan in the search results. If a user searches for a location, location group, material, material group, agreement, shipment or receipt activity type, or any user defined value that appears in an exchange, the supply chain management workspace can display aggregated exchange data in tabular form, based on the columns that a user has selected in the exchange plan editor.

The supply chain management workspace can also include various exchange activities in the search results. If a user searches for a specific exchange ID or any user defined value that appears in an exchange, the supply chain management workspace can display all matching exchanges in tabular form.

The supply chain management workspace can also include production and consumption information in the search results. If a user searches for a location, location group, material, material group, or production or consumption keyword, the supply chain management workspace can display production and consumption data in tabular form.

The supply chain management workspace can also include demand forecast information in the search results. If a user searches for a location, location group, material, or material group, the supply chain management workspace can display demand forecast data in tabular form.

The supply chain management workspace can also include price forecast information in the search results. If a user searches for a location, location group, material, or material group, the supply chain management workspace can display price forecast data in tabular form.

The supply chain management workspace can also include actual inventories information in the search results. If a user searches for a location, location group, material, or material group and also specifically mention actual inventory (e.g. ‘west coast actual inventory’), the supply chain management workspace can display actual inventory data in tabular form.

The supply chain management workspace can also include planned inventories information in the search results. If a user searches for a location, location group, material, or material group and also specifically mention plan inventory (e.g. ‘east coast plan inventory’), the supply chain management workspace can display plan inventory data in tabular form.

The supply chain management workspace can also include inventory limits information in the search results. If a user searches for a location, location group, material, or material group and also specifically mention inventory limits (e.g. ‘east coast inventory limits’), the supply chain management workspace can display inventory limit data in tabular form.

The supply chain management workspace can include also recipes information in the search results. If a user searches for a location, location group, material, or material group and also specifically mention recipes (e.g. ‘east coast recipes’), the supply chain management workspace can display recipe data in tabular form.

Additionally, when a user click on a section header, the supply chain management workspace can open a separate tab that is filtered to display only the information that the user is searching for. The separate tab offers additional features such as interactive charting, calculating totals and editing the information. Each separate section can be collapsed or expanded by clicking on the expander button on its section header. Additionally, the supply chain management workspace can provide collapse all and expand all buttons.

In accordance with an embodiment of the invention, the supply chain management workspace can interpret the search term by selecting tokens from within the search term and can match them with information in the supply chain management environment. Furthermore, the supply chain management workspace can select search result information that matches the search term interpretation in at least one supply chain information category, and generate a search result view containing the result information for at least one supply chain information category, if any contained matching result information, wherein the one or more results can be displayed in different sections.

Additionally, the supply chain management workspace allows the search term to include one or more of a time interval, time period, report name, or activity type, and interpret the time interval, time period, report name or activity type in the search term. Also, the supply chain management workspace can organize supply chain information in the search results by day, week, month or year when the search term interpretation contains a time period keyword of daily, weekly, monthly or yearly.

Furthermore, the supply chain management workspace can determine a set of special duration organizational search keywords, can map each special duration organizational search keyword in the set of special duration organizational search keywords to a duration of time, and can organize information in the searching results based on a mapped duration of time corresponding to the special duration organizational keyword entered by the user. Also, the supply chain management workspace can organize supply chain information in the searching results within a supply chain management environment when the search term interpretation contains a time interval.

### Supply Chain Management Process

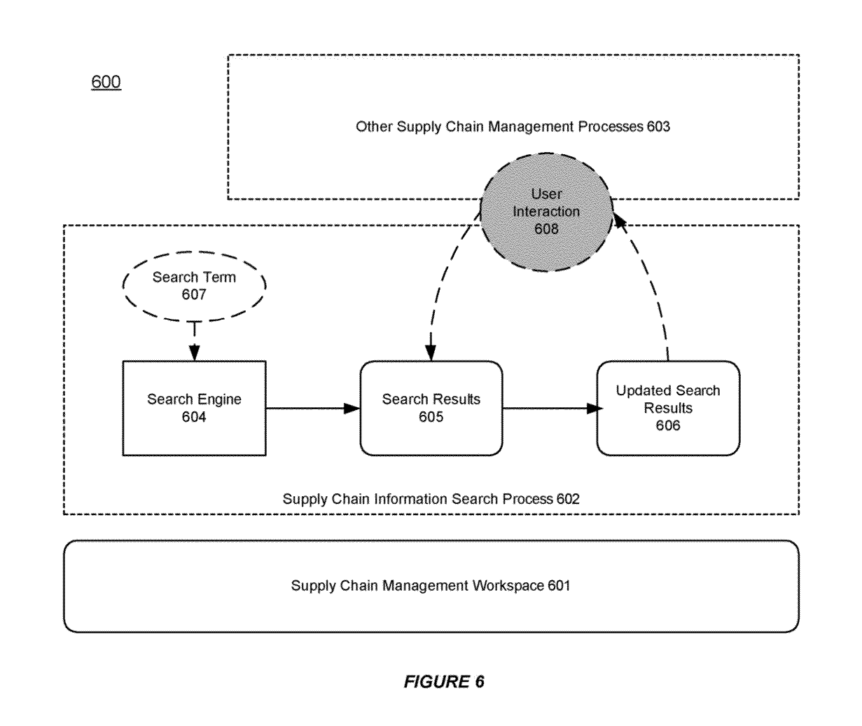

FIG. 6 is an exemplary illustration of supporting a supply chain management process in accordance with an embodiment of the invention.

As shown in FIG. 6, a user can start a supply chain management process in a supply chain management environment by providing a search term to a search engine 604 in a supply chain workspace 601. The search engine 604 can generate one or more search results 605 to be displayed on a user interface and make finding supply chain information within a supply chain workspace 601 simple.

The user can interact with the displayed search results in order to perform one or more supply chain management operations. These supply chain management operations, such as capturing supply chain events, refining the search results based on further information, performing computation in order to forecast a future incident, and review comprehensive reports, can also be a part of other supply chain management processes 603.

Then, the supply chain workspace can update the searching results 606 displayed in different sections based on the user interaction 608.

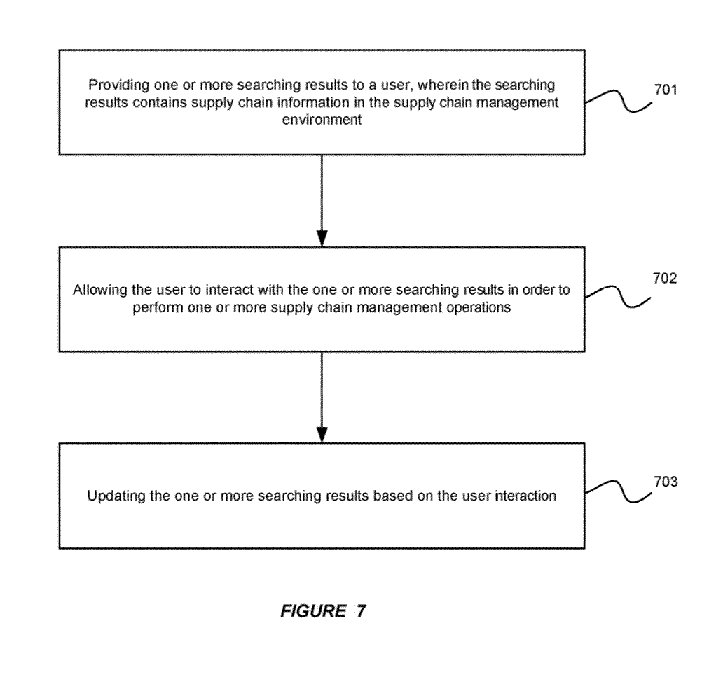

FIG. 7 is an exemplary illustration of a flow diagram for supporting charting in a supply chain management environment, in accordance with various embodiments of the invention. As shown in FIG. 7, at step 701, a supply chain workspace can provide one or more searching results to a user, wherein the searching results contains supply chain information in the supply chain management environment. Then, at step 702, the supply chain workspace allows the user to interact with the one or more searching results in order to perform one or more supply chain management operations. Furthermore, at step 703, the supply chain workspace can update the one or more searching results based on the user interaction.

### An Exemplary Supply Chain Management Workspace

In accordance with an embodiment of the invention, the supply chain management workspace can be either a supply chain management software application, e.g. SIMTO Planning Workspace Pro (PW Pro), or a web service that is based on the supply chain management software.

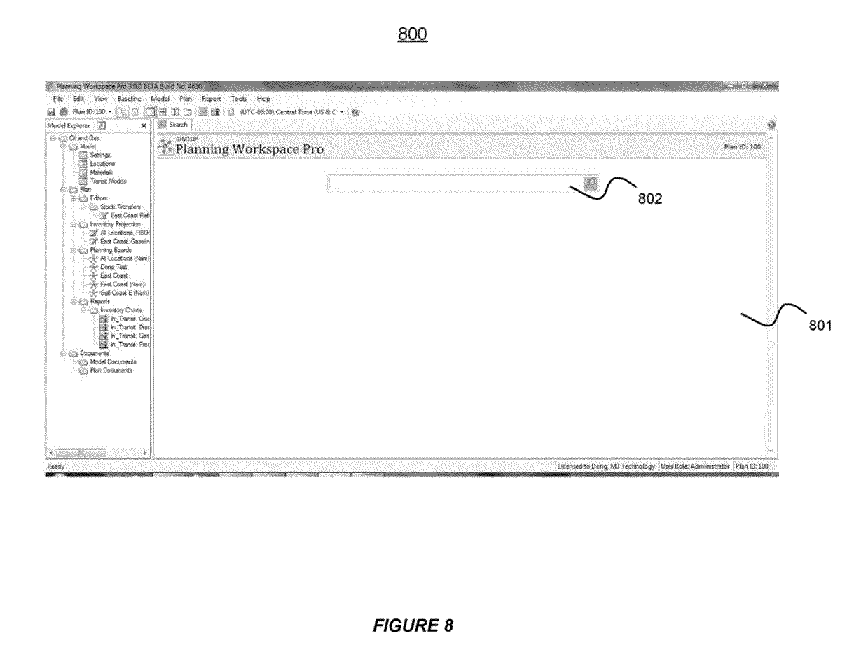

FIG. 8 is an exemplary illustration of starting a search process in an exemplary supply chain management workspace, in accordance with an embodiment of the invention. As shown in FIG. 8, the exemplary supply chain management workspace 800, PW Pro, can provide a search tab 801 that includes a search box 802.

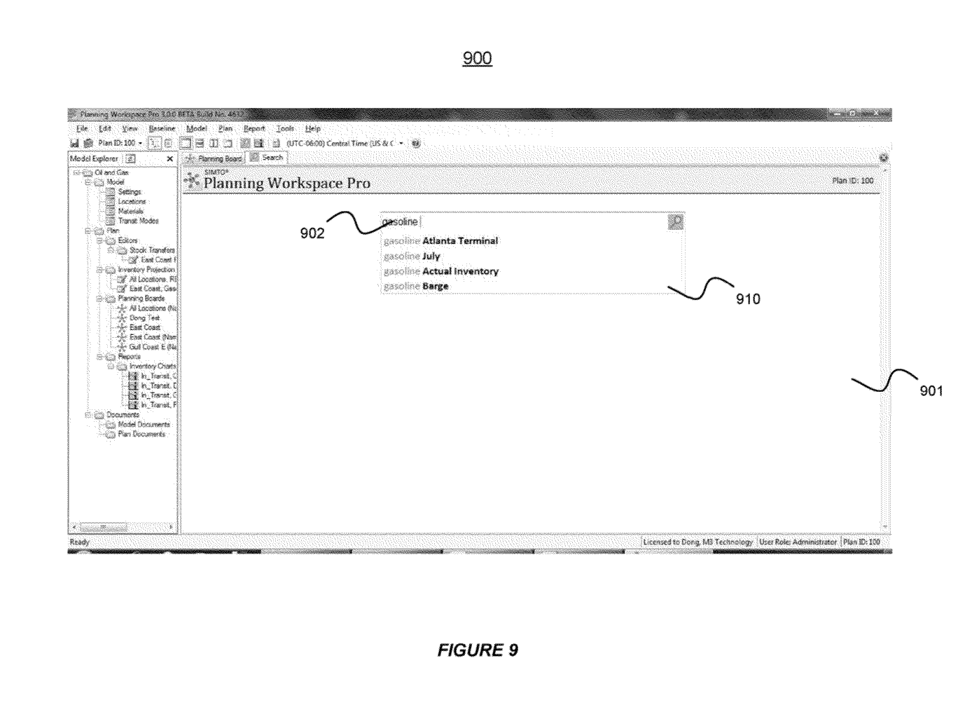

FIG. 9 is an exemplary illustration of providing automatic suggestion for a search process in an exemplary supply chain management workspace in accordance with an embodiment of the invention. As shown in FIG. 9, as user types the word “gasoline” 902 into the search box in the search tab 901, the exemplary supply chain management workspace 900, e.g. PW Pro, can pop up automatic suggestions 910 to help the user to finish entering search terms. These automatic suggests 910 can be based on supply chain data and business intelligence.

In accordance with an embodiment of the invention, the exemplary supply chain management workspace can provide search results based on different categories that a user may be interested in.

The search results can be based on locations and location groups. For example, user can search New York Terminal, or Search East Coast area.

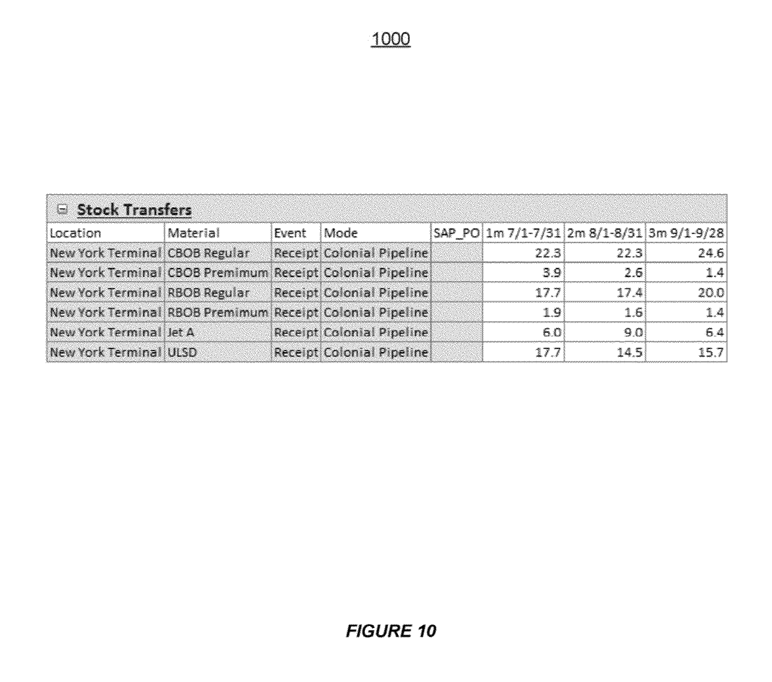

FIG. 10 is an exemplary illustration of displaying search results based on a location in an exemplary supply chain management workspace in accordance with an embodiment of the invention. As shown in FIG. 10, an exemplary supply chain management workspace 1000, e.g. PW Pro, can display stock transfer search results for a search term including “New York Terminal.” The search results can include the stock transfer information of all materials that are shipped from, or received at, the New York Terminal in the supply chain.

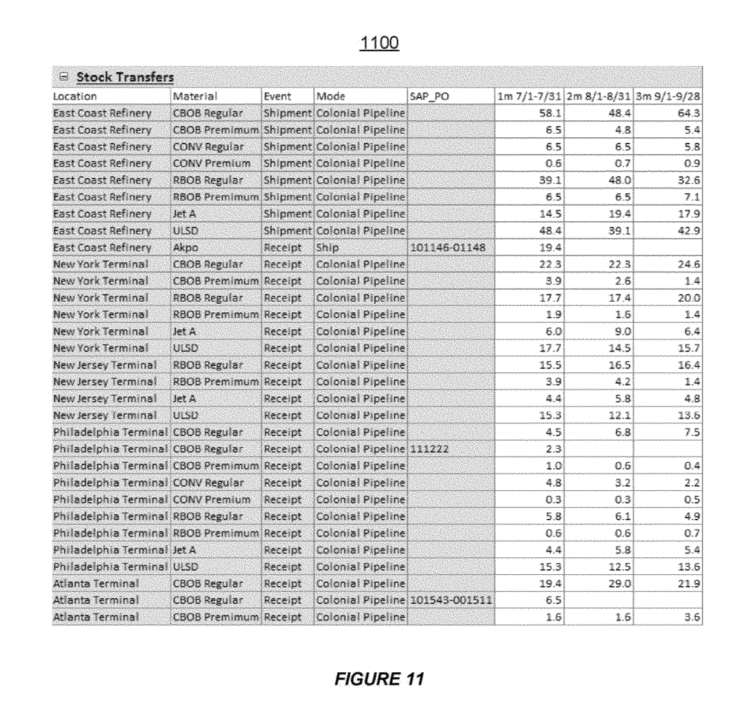

FIG. 11 is an exemplary illustration of displaying search results based on a location group in an exemplary supply chain management workspace in accordance with an embodiment of the invention. As shown in FIG. 11, an exemplary supply chain management workspace 1100, e.g. PW Pro, can display stock transfers search results for a search term including “East Coast area.” The search results can include the stock transfer information of all materials that are shipped from, or received at, all terminals in the east coast (including the aggregated data at the east coast level).

The search results can be based on materials and material groups. For example, user can search for all crude or can search particular crude such as Arab heavy crude.

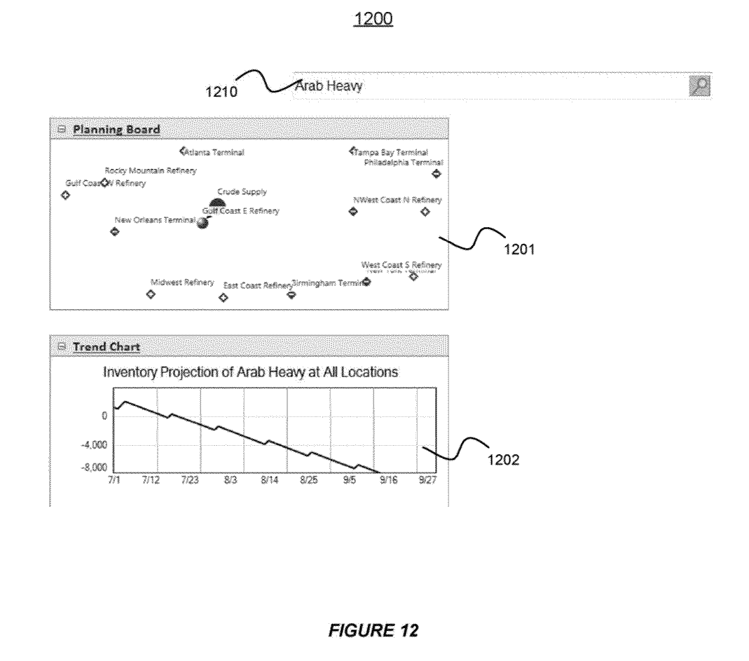

FIG. 12 is an exemplary illustration of displaying search results based on a material in an exemplary supply chain management workspace in accordance with an embodiment of the invention. As shown in FIG. 12, an exemplary supply chain management workspace 1200, e.g. PW Pro, can display a supply chain graph 1201 and a trend chart 1202 for a search term including “Arab Heavy” 1210. Here, the supply chain graph displays supply chain information associated with Arab heavy crude (e.g. the supply, consume, produce, trade, demand, exchange, and transfer information) at all locations, and the trend chart displays inventory projection for the Arab heavy crude at all locations.

The search results can be based on transit modes. User can search a vessel name, model (such as Barge, or Truck), pipeline, airplane, airplane model, and other transit modes.

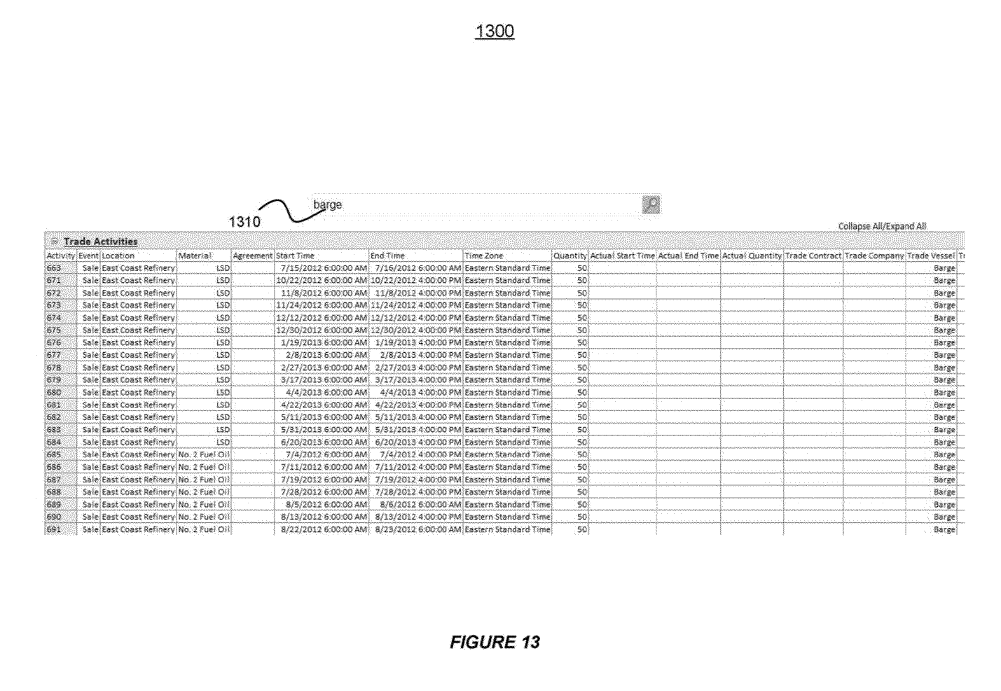

FIG. 13 is an exemplary illustration of displaying search results based on a transit mode in an exemplary supply chain management workspace in accordance with an embodiment of the invention. As shown in FIG. 13, an exemplary supply chain management workspace 1300, e.g. PW Pro, can display all trade activities with trade vessel as a barge, for a search term including “barge” 1310.

The search results can be based on time periods (e.g. daily, weekly, monthly). The search engine can comprehend the definitions for different time periods, and the exemplary supply chain management workspace, e.g. PW Pro, can display search results in monthly, weekly or daily.

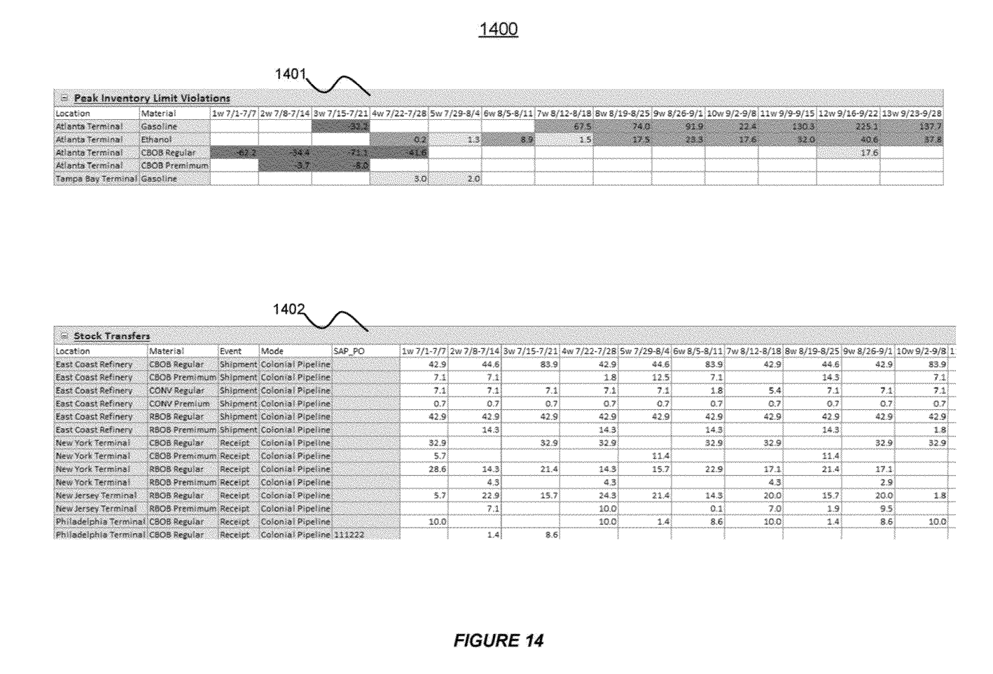

FIG. 14 is an exemplary illustration of displaying search results based on a time period in an exemplary supply chain management workspace in accordance with an embodiment of the invention. As shown in FIG. 14, the exemplary supply chain management workspace 1400, e.g. PW Pro, can display portion of search results, which includes a Peak Inventory Limit Violations section 1401 and a Stock transfer section 1402, in a weekly format for a search term including “East Coast Gasoline Weekly”.

Furthermore, the search results can be based on report names. For example, a user can search for particular report such as Supply Demand balance. Also, the search results can be based on month names. For example, a user can enter data for any particular month(s) such as July or July and August. Also, the search results can be based on agreements. For example, a user can search particular agreements such as Exchange Agreement. Also, the search results can be based on activity types (e.g. purchase, shipment). For example, a user can search any activity, such as trade, purchase, stock transfer. Additionally, the search results can be based on activity and activity group IDs, values in user defined fields.

Moreover, the user can combine any above search terms. For example, a user can search the supply chain using combined search terms, such as “West Coast weekly jet A”, “Gasoline trade west coast daily”, and “Gasoline production daily Gulf Coast”.

In accordance with an embodiment of the invention, the search results can include a Planning Board. UA user can click the supply chain graph of the Planning Board from the search results to open the Planning Board. (Alternatively, the Planning Board can be launched independently from top menu bar and model tree).

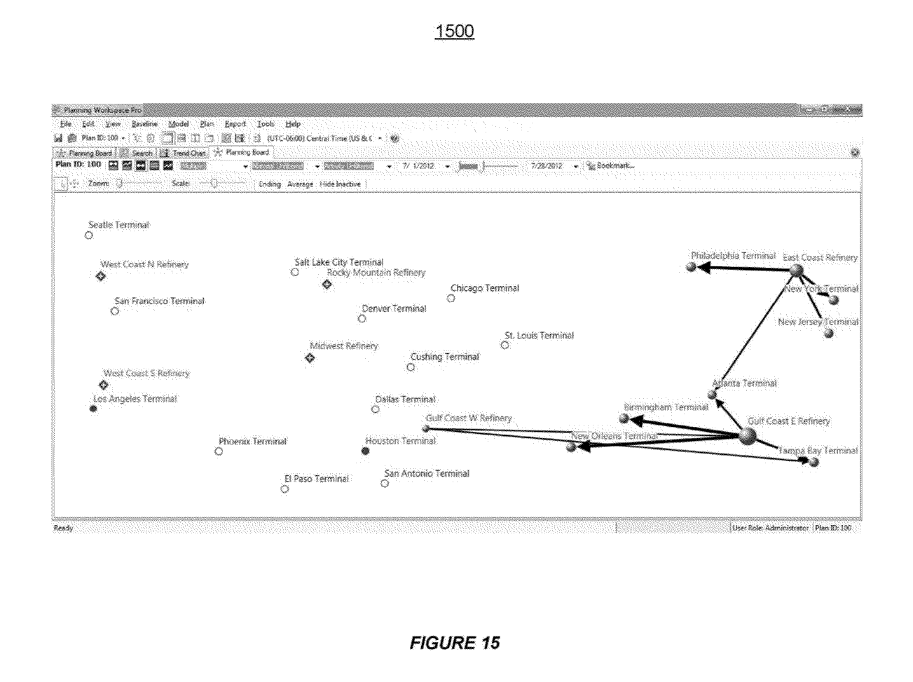

For example, the exemplary supply chain management workspace, e.g. PW Pro, can provide a planning board with five different views: a Graph view, a Trend/Gantt View, a Grid View, a Graph/Grid view, and a Trend/Grid view, which are shown in the following FIGS. 15-19.

FIG. 15 is an exemplary illustration of displaying a Graph View in an exemplary planning board in accordance with an embodiment of the invention.

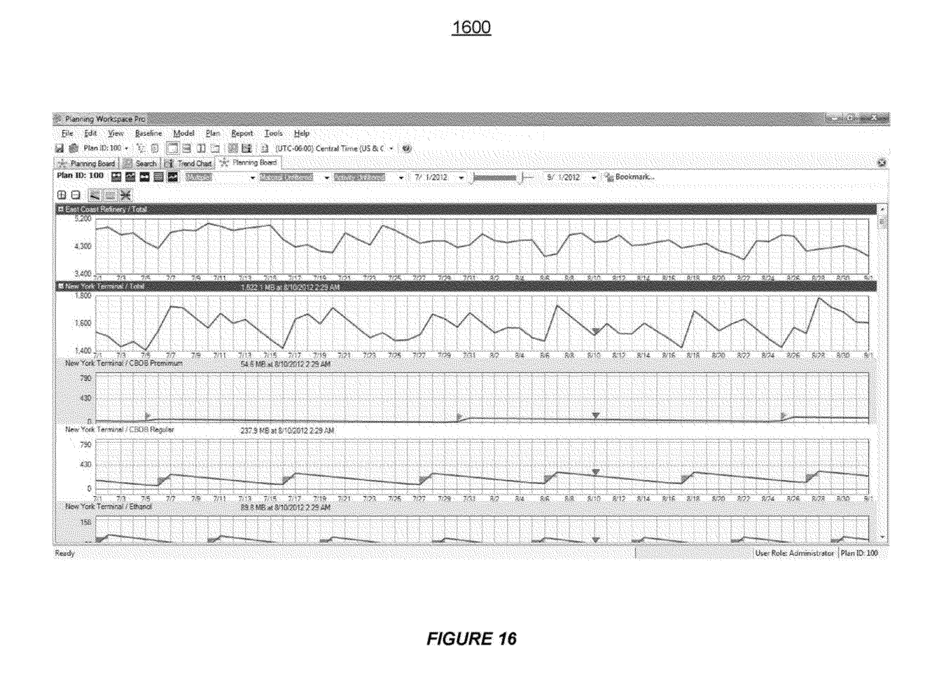

FIG. 16 is an exemplary illustration of displaying a Trend/Gantt View in an exemplary planning board in accordance with an embodiment of the invention.

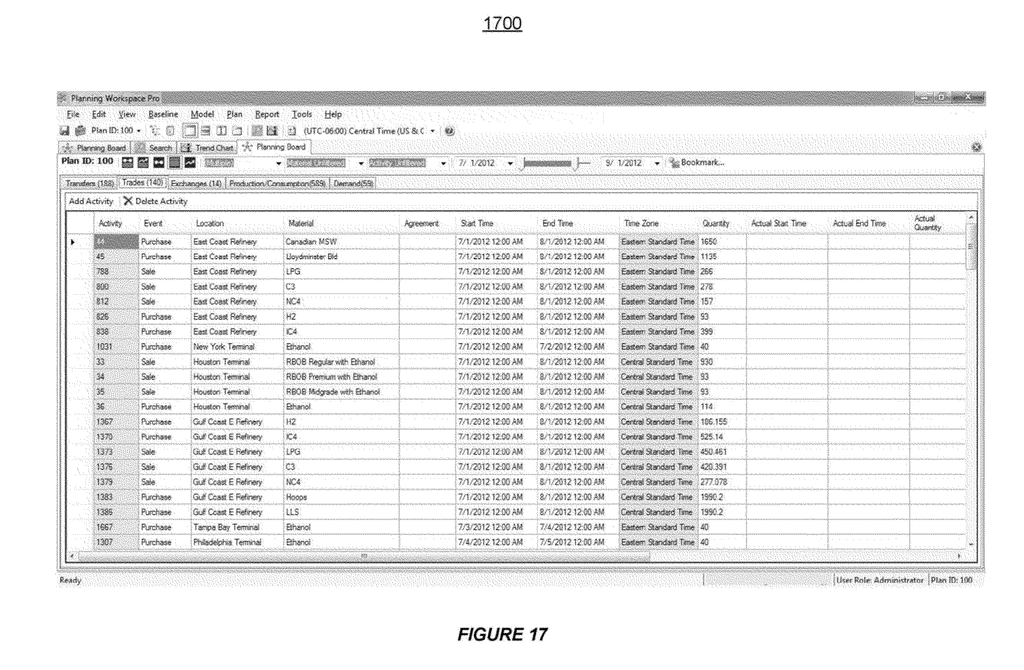

FIG. 17 is an exemplary illustration of displaying a Grid View in an exemplary planning board in accordance with an embodiment of the invention.

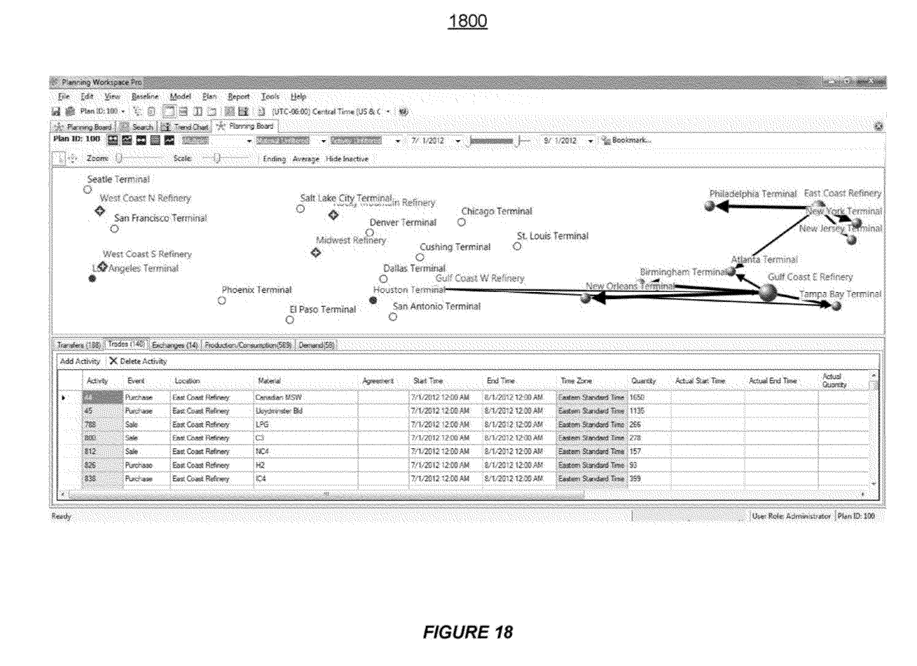

FIG. 18 is an exemplary illustration of displaying a Graph/Grid View in an exemplary planning board in accordance with an embodiment of the invention.

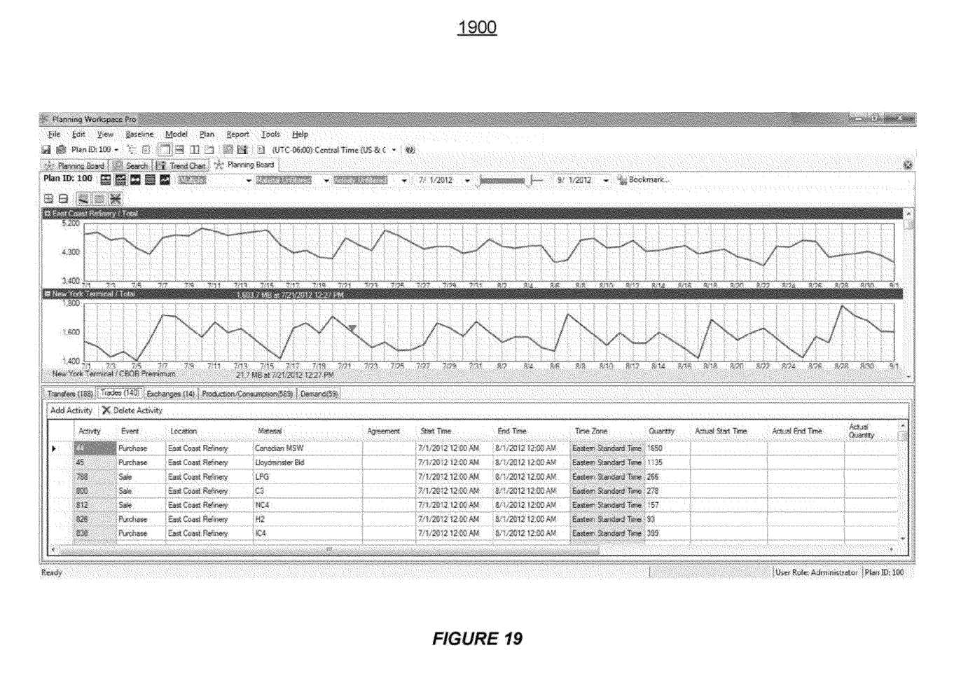

FIG. 19 is an exemplary illustration of displaying a Trend/Grid View in an exemplary planning board in accordance with an embodiment of the invention.

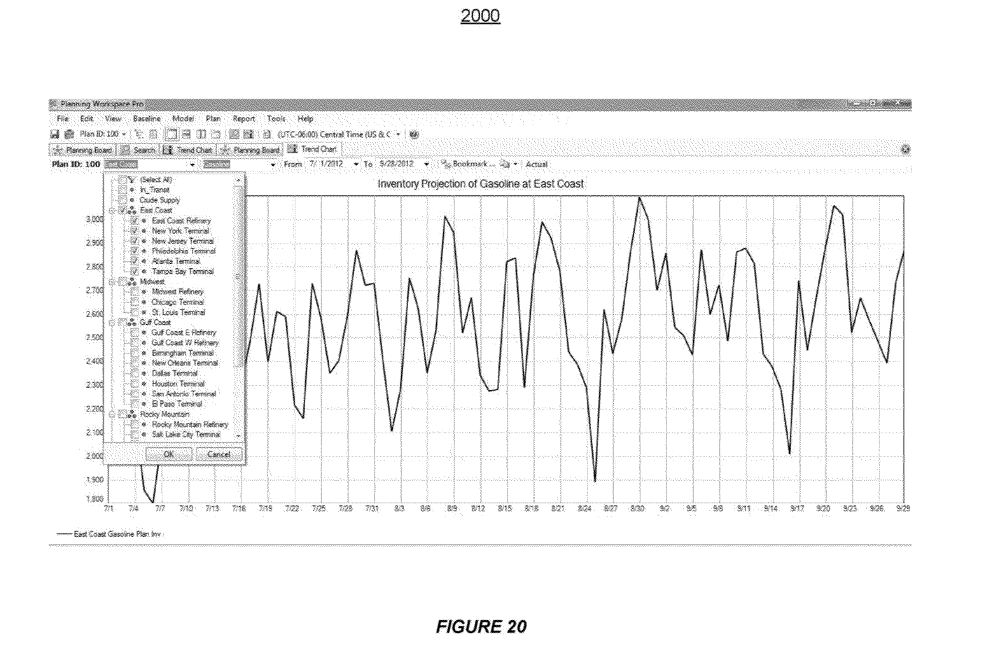

Additionally, the search results can include a Trend Chart, which is shown in FIG. 20.

FIG. 20 is an exemplary illustration of displaying a Trend Chart in an exemplary planning board in accordance with an embodiment of the invention.

A user can click the Trend Chart from the search results to open the Trend Chart. (Alternatively, the Trend Chart can be launched independently from top menu bar and model tree). Furthermore, the user can select different locations or location groups or materials or material groups to display inventory trend.

In accordance with an embodiment of the invention, the displaying of the Planning Board and the Trend Chart can be used as part of a supply chain management process. The exemplary supply chain management workspace, e.g. PW Pro, allows a user to further interact with the displayed Planning Board and Trend Chart to perform various supply chain management tasks.

The present invention may be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

One embodiment includes a computer program product which is a storage medium (media) having instructions stored thereon/in which can be used to program a computer to perform any of the features present herein. The storage medium can include, but is not limited to, any type of disk including floppy disks, optical discs, DVD, CD-ROMs, micro drive, and magneto-optical disks, ROMs, RAMs, EPROMs, EEPROMs, DRAMs, flash memory of media or device suitable for storing instructions and/or data stored on any one of the computer readable medium (media), the present invention can include software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and user applications.

Embodiments of the present invention can include providing code for implementing processes of the present invention. The providing can include providing code to a user in any manner. For example, the providing can include transmitting digital signals containing the code to a user; providing the code on a physical media to a user; or any other method of making the code available.

Embodiments of the present invention can include a computer implemented method for transmitting code which can be executed at a computer to perform any of the processes of embodiments of the present invention. The transmitting can include transfer through any portion of a network, such as the Internet; through wires, the atmosphere or space; or any other type of transmission. The transmitting can include initiating a transmission of code; or causing the code to pass into any region or country from another region or country. For example, transmitting includes causing the transfer of code through a portion of a network as a result of previously addressing and sending data including the code to a user. A transmission to a user can include any transmission received by the user in any region or country, regardless of the location from which the transmission is sent.

Embodiments of the present invention can include a signal containing code which can be executed at a computer to perform any of the processes of embodiments of the present invention. The signal can be transmitted through a network, such as the Internet; through wires, the atmosphere or space; or any other type of transmission. The entire signal need not be in transit at the same time. The signal can extend in time over the period of its transfer. The signal is not to be considered as a snapshot of what is currently in transit.

The forgoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. The modifications and variations include any relevant combination of the disclosed features. For example, steps preformed in the embodiments of the invention disclosed can be performed in alternate orders, certain steps can be omitted, and additional steps can be added. The embodiments where chosen and described in order to best explain the principles of the invention and its practical application, thereby enabling others skilled in the art to understand the invention for various embodiments and with various modifications that are suited to the particular used contemplated. It is intended that the scope of the invention be defined by the claims and their equivalents.

What is claimed is:

1. A method to support searching in a supply chain management environment, comprising:
receiving a token from a user, wherein the token is part of a search term that is adaptive to be used to find supply chain information in the supply chain management environment;
matching the token with a set of supply chain information categories;
generating a set of possible suggestions for at least one said supply chain information category;
selecting a subset of suggestions from the possible suggestions; and
providing suggestions to the user on how to complete the search term in at least one said supply chain information category.

2. The method according to claim 1, further comprising:
allowing the token to be at least one of
one or more characters entered by the user in a search box, and
one or more words in a vocal instruction by the user.

3. The method according to claim 1, further comprising:
interpreting the search term by selecting tokens from within the search term and matching them with information in the supply chain management environment;
selecting search result information that matches the search term interpretation in at least one supply chain information category; and
generating a search result view containing the result information for at least one supply chain information category, if any contained matching result information, wherein the one or more results can be displayed in different sections.

4. The method according to claim 3, further comprising:
allowing the search term to include one or more of a time interval, time period, report name, or activity type; and
interpreting the time interval, time period, report name or activity type in the search term.

5. The method according to claim 4, further comprising:
organizing supply chain information in the search results by day, week, month or year when the search term interpretation contains a time period keyword of daily, weekly, monthly or yearly.

6. The method according to claim 4, further comprising:
determining a set of special duration organizational search keywords;
mapping each special duration organizational search keyword in the set of special duration organizational search keywords to a duration of time; and
organizing information in the searching results based on a mapped duration of time corresponding to the special duration organizational keyword entered by the user.

7. The method according to claim 4, further comprising:
organizing supply chain information in the searching results within a supply chain management environment when the search term interpretation contains a time interval.

8. The method according to claim 7, further comprising:
determining a default time zone for displaying information to the user;
converting one or more search tokens into one or more time intervals within the default time zone;
converting supply chain information stored in Coordinated Universal Time (UTC) into dates and times in the default time zone; and
filtering supply chain information based on the converted time interval.

9. The method according to claim 7, further comprising:
allowing the user to select which time zone to be used as a default time zone.

10. The method according to claim 3, further comprising:
allowing the user to interact with the one or more searching results in order to perform one or more supply chain management operations; and
updating the one or more searching results based on the user interaction.

11. The method according to claim 3, further comprising:
displaying the searching results in sections that are sorted in an order based on a relevance ranking.

12. The method according to claim 11, further comprising:
categorizing supply chain information; and
determining a relevance ranking for each supply chain information category.

13. The method according to claim 11, further comprising:
establishing a fixed relevance ranking for each supply chain information category.

14. The method according to claim 11, further comprising:
storing user interaction information in search requests; and
calculating a relevance ranking for each supply chain information category based on stored user interaction information.

15. The method according to claim 11, further comprising:
storing feasibility information about a supply chain plan; and
calculating a relevance ranking for each supply chain information category based on stored feasibility information about a supply chain plan.

16. A system to support supply chain management, comprising:
one or more microprocessors;
a supply chain management workspace running on the one or more microprocessors, wherein the supply chain management workspace operates to perform the steps comprising:
receiving a token from a user, wherein the token is part of a search term that is adaptive to be used to find supply chain information in the supply chain management environment;
matching the token with a set of supply chain information categories;
generating a set of possible suggestions for at least one said supply chain information category;
selecting a subset of suggestions from the possible suggestions; and
providing suggestions to the user on how to complete the search term in at least one said supply chain information category.

17. A machine readable medium having instructions stored thereon that when executed cause a system to:
receiving a token from a user, wherein the token is part of a search term that is adaptive to be used to find supply chain information in the supply chain management environment;
matching the token with a set of supply chain information categories;
generating a set of possible suggestions for at least one said supply chain information category;
selecting a subset of suggestions from the possible suggestions; and
providing suggestions to the user on how to complete the search term in at least one said supply chain information category.
